(19) United States
(12) Patent Application Publication
(10) Pub. No.: US 2025/0191855 A1
(43) Pub. Date: Jun. 12, 2025

(54) PROCESS FOR SYNTHESIZING COPPER-SUPPORTED COBALT-DOPED BISMUTH OXIDE NANOMATERIAL ELECTRODE FOR SUPERCAPACITOR APPLICATIONS

(71) Applicant: Princess Nourah bint Abdurahman University, Riyadh (SA)

(72) Inventors: Mohd Ubaidullah, Riyadh (SA); Mohd. Shkir, Abha (SA); Rushikesh G. Bobade, Maharashtra (IN); Thamraa Alshahrani, Riyadh (SA); Bidhan Pandit, London (GB); Revanappa C. Ambare, Maharashtra (IN); Anuj Kumar, Mathura (IN); Zonghua Pu, Fujian, Fuzhou (CN); Yufeng Zhao, Shanghai (CN); Abdullah M Al-Enizi, Riyadh (SA); Atif Mossad Ali, Abha (SA); M. Aslam Manthrammel, Abha (SA)

(21) Appl. No.: 19/020,395

(22) Filed: Jan. 14, 2025

(51) Int. Cl. H01G 11/86; B82Y 30/00; B82Y 40/00; H01G 11/46

(52) U.S. Cl. CPC H01G 11/86; B82Y 30/00; B82Y 40/00; H01G 11/46

(57) ABSTRACT

The present invention relates to a process for synthesizing copper-supported cobalt-doped bismuth oxide nanomaterial electrode for supercapacitor applications. For the synthesis of said nanomaterial electrode, Successive Ionic Layer Adsorption and Reaction (SILAR) technique is used. The present invention carried out the maticulous fabrication of copper-supported cobalt doped Bi₂O₃ nanomaterial electrode, wherein the synthesized nanomaterial electrode, harnesses the unique properties of each constituent material to achieve superior electrochemical performance. Through precise control of SILAR parameters, including deposition cycles and solution concentrations, a finely tuned composite material is produced, characterized by enhanced conductivity, stability, and specific capacitance. The strategic incorporation of copper and cobalt doping within the Bi₂O₃ matrix synergistically enhances the overall electrochemical behavior, facilitating efficient charge transfer and storage.

### FIELD OF THE INVENTION

The present disclosure relates to a process for synthesizing copper-supported cobalt-doped bismuth oxide nanomaterial electrode for supercapacitor applications. In more particular manner, the present disclosure relates to a process for synthesizing Copper Supported Cobalt-Doped Bi₂O₃ Nanomaterials by using successive ionic layer adsorption and reaction (SILAR) technique, wherein synthesized nanoparticles are highly promising solution electrode solution tailored for supercapacitor applications.

### BACKGROUND OF THE INVENTION

In the development of supercapacitors, it is important to have material that provides high energy and power densities, stability, and longevity. Various prior arts are focused on utilizing various approaches and materials to make supercapacitor having high energy storage capacity. However, existing electrode materials often face limitations such as low specific capacitance, and poor conductivity, resulting in lower electrode performance, leading to low-capacitor supercapacitor.

From various prior arts, it has been observed that Bi₂O₃ exhibits promising electrochemical properties, but its inherent low conductivity restricts its performance in practical applications. However, doping with a transition metal, like cobalt, will enhance its charge storage capacity and conductivity. However, challenges remain in optimizing the doping levels, ensuring uniform distribution of dopants. Furthermore, it becomes important to have suitable substrate material. Herein, copper provides high electrical conductivity. However, limitations and problems in the existing fabrication techniques for integrating doped materials on copper surfaces often result in poor performance of the electrode, especially in terms of achieving high capacitance and long-term stability.

The aforementioned problem can be solved by utilizing a more efficient electrode fabrication methodology which makes it able to achieve harmonious amalgamation of materials for fabrication of electrode with efficient performance.

In the view of the foregoing discussion, it is clearly portrayed that there is a need for a process for synthesizing copper-supported cobalt-doped bismuth oxide nanomaterial electrode for supercapacitor applications. The electrode synthesized using the proposed process exhibits enhanced electrochemical properties and enhanced structural integrity.

### SUMMARY OF THE INVENTION

The present disclosure relates to a process for synthesizing copper-supported cobalt-doped bismuth oxide nanomaterial electrodes for supercapacitor applications. The present invention relates to a process for synthesizing copper-supported cobalt-doped Bi₂O₃ nanomaterial electrodes by using successive ionic layer adsorption and reaction (SILAR) techniques. The synthesized electrode is a promising electrode for supercapacitor applications. The synthesized electrode harnesses the unique properties of each constituent material and achieves superior electrochemical performance. In the process of synthesizing the said nanomaterial electrode, through price control of SILAR parameters, which includes deposition cycles and solution concentrations, a fine-tuned composite material is prepared, which exhibits enhanced conductivity, stability, and specific capacitance. In the synthesized nanomaterial electrode, incorporating copper and cobalt doping within the Bi₂O₃ matrix synergistically enhances the overall electrochemical behavior, facilitating efficient charge transfer and storage.

The present disclosure seeks to provide a Copper-supported Cobalt-doped Bismuth oxide nanomaterial electrode composition for supercapacitor applications. The composition comprises: 10% molar ratio of cobalt(II) nitrate hexahydrate Co(NO₃)₂·6H₂O; 90% molar ratio of 0.1 M Bismuth(III) nitrate pentahydrate Bi(NO₃)₃·5H₂O solution with a small quantity of nitric acid (HNO₃); and 1 M NaOH in deionized water.

In an embodiment, the weight percentage of the cobalt(II) nitrate hexahydrate Co(NO₃)₂·6H₂O, Bismuth(III) nitrate pentahydrate Bi(NO₃)₃·5H₂O solution, nitric acid (HNO₃), and deionized water, is, . . . , respectively.

The present disclosure seeks to provide a process for synthesizing copper-supported cobalt-doped bismuth oxide nanomaterial electrode for supercapacitor applications. The process comprises: preparing a 0.1 M Bismuth(III) nitrate pentahydrate Bi(NO₃)₃·5H₂O solution as the cationic precursor and mixing with a small quantity of nitric acid (HNO₃) for solubility; stirring cationic solution for 4-5 hours; doping the cationic solution by adding a 10% molar ratio of cobalt(II) nitrate hexahydrate Co(NO₃)₂·6H₂O to 90% molar ratio of 0.1 M Bismuth(III) nitrate pentahydrate Bi(NO₃)₃·5H₂O solution to form a doped solution; immersing a pre-cleaned copper substrate in an anionic precursor solution of OH⁻ ions, prepared by diluting 1 M NaOH in deionized water, for 60 seconds; repeating the immersion cycle 50-100 times to form a thin film on the copper substrate; and drying the coated copper substrate at room temperature for 12 hours, followed by annealing at 400-100 K for 0.5-2 hours to convert the hydroxide film into a composite oxide film.

In an embodiment, the cobalt-doped bismuth oxide thin films are deposited using a successive ionic layer adsorption and reaction (SILAR) technique to create CoBiCu₃₀₀ thin films exhibit improved electrochemical performance.

In an embodiment, the pre-cleaning of the copper substrate comprises steps of: polishing the copper substrate using polishing paper to achieve a refined surface; subjecting the polished copper substrate to ultrasonic cleaning in a 10% hydrochloric acid (HCl) solution for 30-40 minutes to ensure thorough surface preparation; rinsing the cleaned copper substrate with acetone to remove any residual contaminants after ultrasonic cleaning; and rinsing the copper substrate with distilled water after acetone rinsing to eliminate any remaining chemical residues.

In an embodiment, the coated copper substrate is annealed at 573 K for 1 hour to convert the hydroxide film into a composite oxide film comprising Co₃O₄, Bi₂O₃, and CuO.

In an embodiment, the copper substrate is polished using 1200-grade polishing paper.

In an embodiment, the cobalt-doped bismuth oxide layer has a molar ratio of cobalt to bismuth of about 10:90.

In an embodiment, the cobalt-doped bismuth oxide layer is formed by a successive ionic layer adsorption.

In an embodiment, the immersion steps are repeated about 70 times.

An objective of the present disclosure is to provide a process for synthesizing copper-supported cobalt-doped bismuth oxide nanomaterial electrode for supercapacitor applications.

Another objective of the present disclosure is to synthesize Copper Supported Cobalt-Doped Bi₂O₃ Nanomaterials electrode.

Another objective of the present disclosure is to use successive ionic layer adsorption, and reaction (SILAR) technique for the synthesis of said electrode.

Another objective of the present disclosure is to perform precise control of SILAR parameter during the synthesis of the nanomaterial, to synthesize a finely tuned composite material exhibiting enhanced conductivity, stability, and specific capacitance.

Yet, another object of the present disclosure is to incorporate copper and cobalt doping within the Bi₂O₃ matrix synergistically enhances the overall electrochemical behavior.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a flow chart of a process for synthesizing copper-supported cobalt-doped bismuth oxide nanomaterial electrode for supercapacitor applications in accordance with an embodiment of the present disclosure;

FIG. 2 illustrates (a) XRD data of sample CoBiCu₃₀₀, (b) survey spectra of sample CoBiCu₃₀₀, deconvoluted XPS of (c) Bi 4f, (d) Cu 2p, (e) O 1s, (f) XPS valance band spectra of sample CoBiCu₃₀₀, in accordance with an embodiment of the present disclosure;

FIG. 3 illustrates (a-b) FE-SEM images of sample CoBiCu300, (c) Elemental mapping images of a sample CoBiCu300, (d) Bi, (e) Co, (f) Cu, (g) O. and inset of (c) EDAX spectra of sample CoBiCu₃₀₀ in accordance with an embodiment of the present disclosure; and

FIG. 4 illustrates (a) The CV curve of electrode CoBiCu300 at dissimilar scan rate in 1M KOH electrolyte, (b) Regon plot of Cs in F/g vs sweep rate in mV/s, (c) GCD plot of electrode CoBiCu300 at different current density in mA/cm2, (d) Regon plot of SE vs SP of electrode CoBiCu300, (e) stability curve of electrode CoBiCu300 in 1M KOH electrolyte, (f) EIS Nyquist plot and its Matched Nyquist plot with circuit of electrode CoBiCu₃₀₀ in accordance with an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

The present invention provides Copper-supported Cobalt-doped Bismuth oxide nanomaterial electrode composition for supercapacitor applications, comprising: a 10% molar ratio of cobalt(II) nitrate hexahydrate Co(NO₃)₂·6H₂O; 90% molar ratio of 0.1 M Bismuth(III) nitrate pentahydrate Bi(NO₃)₃·5H₂O solution with a small quantity of nitric acid (HNO₃); and 1 M NaOH in deionized water.

In an embodiment, the weight percentage of the cobalt(II) nitrate hexahydrate Co(NO₃)₂·6H₂O, nitric acid (HNO₃), cobalt(II) nitrate hexahydrate Co(NO₃)₂·6H₂O, Bismuth(III) nitrate pentahydrate Bi(NO₃)₃·5H₂O solution, nitric acid (HNO₃), and deionized water, is, . . . , respectively.

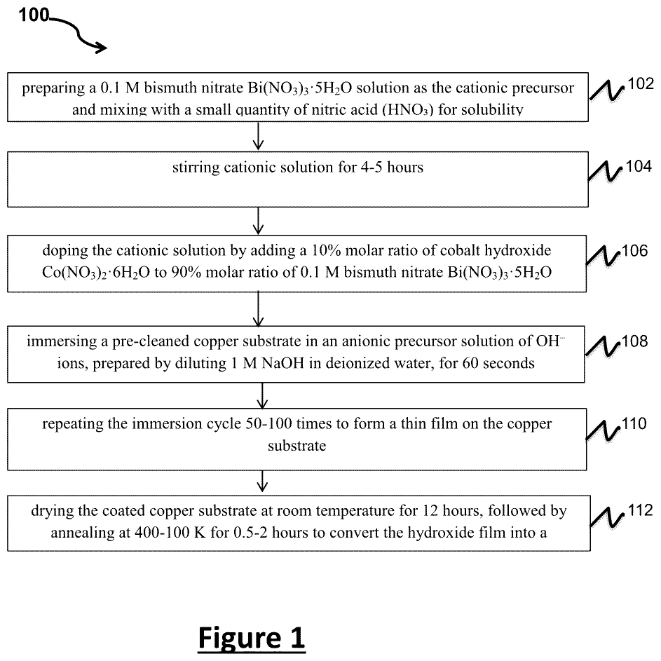

FIG. 1 illustrates a flow chart of a process (100) for synthesizing copper-supported cobalt-doped bismuth oxide nanomaterial electrode for supercapacitor applications in accordance with an embodiment of the present disclosure.

Referring to FIG. 1, the process (100) includes a plurality of steps as described under:

At step (102), the process (100) includes preparing a 0.1 M Bismuth(III) nitrate pentahydrate Bi(NO₃)₃·5H₂O solution as the cationic precursor and mixing with a small quantity of nitric acid (HNO₃) for solubility.

At step (104), the process (100) includes stirring cationic solution for 4-5 hours.

At step (106), the process (100) includes doping the cationic solution by adding a 10% molar ratio of cobalt(II) nitrate hexahydrate Co(NO₃)₂·6H₂O to 90% molar ratio of 0.1 M Bismuth(III) nitrate pentahydrate Bi(NO₃)₃·5H₂O solution to form a doped solution.

At step (108), the process (100) includes immersing a pre-cleaned copper substrate in an anionic precursor solution of OH⁻ ions, prepared by diluting 1 M NaOH in deionized water, for 60 seconds.

At step (110), the process (100) includes repeating the immersion cycle 50-100 times to form a thin film on the copper substrate.

At step (112), the process (100) includes drying the coated copper substrate at room temperature for 12 hours, followed by annealing at 400-100 K for 0.5-2 hours to convert the hydroxide film into a composite oxide film.

In an embodiment, the cobalt-doped bismuth oxide thin films are deposited using a successive ionic layer adsorption and reaction (SILAR) technique to create CoBiCu₃₀₀ thin films exhibit improved electrochemical performance.

In an embodiment, the pre-cleaning of the copper substrate comprises steps of: polishing the copper substrate using polishing paper to achieve a refined surface; subjecting the polished copper substrate to ultrasonic cleaning in a 10% hydrochloric acid (HCl) solution for 30-40 minutes to ensure thorough surface preparation; rinsing the cleaned copper substrate with acetone to remove any residual contaminants after ultrasonic cleaning; and rinsing the copper substrate with distilled water after acetone rinsing to eliminate any remaining chemical residues.

In an embodiment, the coated copper substrate is annealed at 573 K for 1 hour to convert the hydroxide film into a composite oxide film comprising Co₃O₄, Bi₂O₃, and CuO.

In an embodiment, the copper substrate is polished using 1200-grade polishing paper.

In an embodiment, the cobalt-doped bismuth oxide layer has a molar ratio of cobalt to bismuth of about 10:90.

In an embodiment, the cobalt-doped bismuth oxide layer is formed by a successive ionic layer adsorption.

In an embodiment, the immersion steps are repeated about 70 times.

The present invention relates to a process for synthesizing Copper Supported Cobalt-Doped Bi₂O₃ Nanomaterials electrodes, wherein for synthesis Successive Ionic Layer Adsorption and Reaction (SILAR) technique are employed, wherein synthesized electrode is a promising electrode for supercapacitor applications.

In an embodiment, the annealing at 573 K is preceded by a preheating stage at 200 K for 20 minutes to gradually remove residual moisture and volatile compounds, preventing microcrack formation in the Co₃O₄—Bi₂O₃—CuO composite layer, and wherein the conversion of the hydroxide film into a composite oxide film is further enhanced by a rapid cooling phase after annealing, wherein the substrate is exposed to an ice bath for 2 minutes to induce phase separation and create an improved electrochemical interface.

In this embodiment, the annealing process is preceded by a preheating stage at 200 K for 20 minutes to gradually remove residual moisture and volatile compounds from the hydroxide film. This controlled preheating helps prevent the formation of microcracks in the Co₃O₄—Bi₂O₃—CuO composite layer during the subsequent annealing step at 573 K. By gradually increasing the temperature, the risk of rapid evaporation or thermal stress is minimized, which ensures that the film's integrity remains intact, ultimately improving the mechanical properties and stability of the composite oxide film. The preheating process enhances the uniformity of the phase transition, ensuring that the desired composite oxide phases are formed without defects.

Furthermore, a rapid cooling phase is introduced after the annealing step by exposing the substrate to an ice bath for 2 minutes. This rapid cooling induces phase separation, which plays a crucial role in optimizing the electrochemical interface of the material. The quick reduction in temperature encourages the formation of fine-grained phases with distinct interfaces that improve ion conductivity and charge storage capabilities. This technique enhances the overall electrochemical performance of the electrode, particularly in supercapacitor applications where efficient charge-discharge cycles and high surface area are critical for optimal performance. The combination of these carefully controlled thermal treatments results in a more robust and high-performance Co₃O₄—Bi₂O₃—CuO composite film with enhanced electrochemical properties, ensuring long-term stability and higher capacitance retention. The annealing process with the preheating and rapid cooling steps was tested to evaluate its effects on the structural and electrochemical properties of the Co₃O₄—Bi₂O₃—CuO composite film. X-ray diffraction (XRD) analysis revealed a distinct improvement in the phase purity of the composite oxide film after the preheating and rapid cooling stages, compared to the control group where the substrate underwent a direct annealing at 573 K without preheating or rapid cooling. The XRD peaks corresponding to Co₃O₄, Bi₂O₃, and CuO were sharper and more intense, indicating higher crystallinity and phase homogeneity in the composite material.

Scanning electron microscopy (SEM) images confirmed that the preheating step helped prevent the formation of microcracks, as the surface morphology of the composite layer was smooth and uniform. In contrast, the control sample showed signs of microcracking and uneven surface coverage, likely due to the thermal stress induced during the rapid heating.

The electrochemical performance, evaluated through cyclic voltammetry (CV) and galvanostatic charge-discharge (GCD) tests, demonstrated a significant improvement in the capacitance retention and charge-discharge efficiency for the samples treated with preheating and rapid cooling. Specifically, the material subjected to the preheating and rapid cooling stages exhibited a higher specific capacitance (up to 20% greater) and enhanced rate capability compared to the control sample. The rapid cooling induced phase separation contributed to an improved electrochemical interface, leading to better ion mobility and higher capacitance retention during repeated charge-discharge cycles.

In an embodiment, the annealing temperature is incrementally increased by 10 K every 15 minutes from 300 K to 573 K, under a controlled nitrogen atmosphere at a flow rate of 150 Standard Cubic Centimeters per Minute (sccm), to minimize any rapid thermal expansion that could cause delamination of the film, and wherein the film thickness is controlled by adjusting the number of SILAR cycles and maintaining a constant precursor concentration, resulting in a highly uniform thin film with a thickness of 70 nm±5 nm, as verified by profilometry, and wherein the cobalt-doped bismuth oxide film exhibits an average crystallite size of 20-30 nm, determined by X-ray diffraction (XRD), after annealing, which improves the charge storage capacity of the electrode material.

In this embodiment, the annealing process is carefully controlled to avoid rapid thermal expansion, which can lead to defects such as delamination in the cobalt-doped bismuth oxide thin film. The annealing temperature is incrementally increased by 10 K every 15 minutes, from an initial temperature of 300 K up to 573 K. This gradual increase in temperature ensures a controlled thermal transition, reducing the risk of thermal stress and enhancing the structural integrity of the film. The annealing is carried out in a controlled nitrogen atmosphere at a flow rate of 150 sccm to maintain a stable environment, preventing unwanted oxidation or contamination of the film during the process. The gradual heating approach not only minimizes thermal shock but also promotes uniform grain growth, leading to a more consistent material structure.

The film thickness is precisely controlled by adjusting the number of SILAR (Successive Ionic Layer Adsorption and Reaction) cycles and maintaining a constant precursor concentration. This results in a highly uniform thin film with a targeted thickness of 70 nm±5 nm, as verified by profilometry, ensuring that the material maintains consistent electrochemical properties across the substrate. Profilometry measurements confirm the uniformity of the film thickness across the entire substrate, demonstrating that the process produces a well-defined and reproducible layer.

X-ray diffraction (XRD) analysis of the cobalt-doped bismuth oxide film after annealing reveals that the film exhibits an average crystallite size of 20-30 nm. This crystallite size is optimal for improving the charge storage capacity of the electrode material, as it enhances the surface area and provides more active sites for charge accumulation. The fine control over crystallite size contributes to the enhanced electrochemical properties of the material, including higher capacitance and improved charge/discharge efficiency. The smaller crystallites also favor faster ion diffusion, further boosting the performance of the material in supercapacitor applications.

These combined factors—gradual annealing, controlled film thickness, and optimized crystallite size—result in a highly effective cobalt-doped bismuth oxide film that is ideal for energy storage applications, particularly supercapacitors, where high capacitance, long cycling stability, and fast charge/discharge cycles are critical for performance.

In an embodiment, a pulsed electric field is applied at a frequency of 1 Hz with a 1-second on-time and 1-second off-time, generating a peak electric field strength of 1.2 V/cm to enhance the ion diffusion rate and increase the doping efficiency during each cycle, and wherein the pulsed electric field is generated using a square wave signal with a duty cycle of 50% during immersion, resulting in a more homogeneous ion distribution and an increase in the adhesion strength of the cobalt-doped bismuth oxide layer on the copper substrate, and wherein the pulsed electric field is applied in conjunction with an alternating magnetic field at 0.5 mT to further promote ion migration and prevent agglomeration of cobalt and bismuth ions during the deposition process.

In this embodiment, a pulsed electric field is applied during the deposition process to significantly enhance ion diffusion and increase the doping efficiency of cobalt ions into the bismuth oxide matrix. The pulsed electric field is applied at a frequency of 1 Hz with a 1-second on-time and a 1-second off-time, generating a peak electric field strength of 1.2 V/cm. This intermittent electric field encourages better ion migration, facilitating the incorporation of cobalt ions into the growing bismuth oxide thin film. The pulsed nature of the field allows for controlled ion transport, preventing excess accumulation of ions and ensuring more uniform doping across the substrate surface.

The electric field is generated using a square wave signal with a duty cycle of 50%, which results in an equal duration of applied voltage and relaxation periods during each immersion cycle. This balanced electric field promotes more homogeneous ion distribution, reducing the possibility of clustering or inhomogeneous deposition of ions that could otherwise lead to material defects. The consistent application of the field enhances the adhesion strength of the cobalt-doped bismuth oxide layer on the copper substrate, ensuring that the film remains firmly attached and resilient during subsequent processing steps.

Additionally, the pulsed electric field is applied in conjunction with an alternating magnetic field at a strength of 0.5 mT. The combination of the electric and magnetic fields promotes the migration of ions through the solution, further enhancing the uniformity of ion incorporation into the film. The magnetic field helps prevent the agglomeration of cobalt and bismuth ions, which can cause localized areas of high concentration and reduce the overall homogeneity of the film. By preventing ion clustering, the deposition process becomes more efficient, yielding a thin film with a consistent composition and improved electrochemical properties.

In an embodiment, the immersion in the doped cationic solution is performed under continuous ultrasonic agitation at 40 kHz to enhance ion diffusion and promote the formation of densely packed nanostructures, wherein each immersion cycle includes a cathodic polarization step at −0.2 V versus Ag/AgCl for 15 seconds to enhance the selective reduction and deposition of cobalt ions onto the copper substrate, and wherein the cationic solution is stirred at a constant rate of 350 rpm using a magnetic stirrer for the entire 4-5 hour period to maintain homogeneity and prevent precipitation of Bi³⁺ and Co²⁺ ions before SILAR deposition.

In this embodiment, the process for depositing cobalt-doped bismuth oxide thin films involves a carefully controlled immersion in the doped cationic solution, enhanced by continuous ultrasonic agitation at a frequency of 40 kHz. The ultrasonic agitation promotes increased ion diffusion, ensuring that cobalt and bismuth ions are evenly distributed throughout the solution and readily available for incorporation into the growing film. This agitation facilitates the formation of densely packed nanostructures in the thin film, which is critical for achieving a high surface area and improved electrochemical performance, particularly for applications such as supercapacitors.

Each immersion cycle includes a cathodic polarization step at −0.2 V versus Ag/AgCl for 15 seconds, which further enhances the selective reduction and deposition of cobalt ions onto the copper substrate. This step is essential for ensuring that the cobalt ions are efficiently reduced at the substrate surface, where they contribute to the formation of the cobalt-doped bismuth oxide composite layer. By applying a controlled cathodic potential, the process selectively favors the deposition of cobalt without causing unwanted oxidation of the copper substrate, which could lead to reduced film quality or substrate degradation.

Additionally, the cationic solution is stirred at a constant rate of 350 rpm using a magnetic stirrer throughout the entire 4-5 hour period of the immersion process. This consistent stirring ensures that the solution remains homogeneous, preventing the precipitation of Bi³⁺ and Co²⁺ ions before they can participate in the SILAR deposition process. By maintaining a uniform distribution of ions, the process ensures that each deposition cycle occurs with a consistent ion concentration, resulting in a more uniform and high-quality thin film. The prevention of ion precipitation is crucial for avoiding the formation of unwanted phases or irregularities in the film structure.

In an embodiment, the copper substrate surface is chemically etched using a 0.1 M ammonium persulfate (NH₄)₂S₂O₈ solution for exactly 90 seconds prior to SILAR deposition to create micro-roughness, improving mechanical interlocking and adhesion of the thin film, wherein the cobalt-doped bismuth oxide layer is engineered to exhibit a bimodal pore size distribution with mesopores of 2-5 nm and macropores of 50-100 nm, achieved by incorporating 0.05 wt % polyethylene glycol (PEG-4000) as a porogen during the cationic precursor preparation, and wherein the copper substrate is pre-cleaned using a dual-stage process, consisting of first an ultrasonic cleaning in a 2% isopropyl alcohol solution for 20 minutes, followed by a 15-minute treatment in a 0.1 M HCl solution to remove any oxide layer, before proceeding to immersion in the NaOH solution.

In this embodiment, the process begins with the chemical etching of the copper substrate surface using a 0.1 M ammonium persulfate (NH₄)₂S₂O₈ solution for exactly 90 seconds prior to the SILAR deposition process. The etching creates micro-roughness on the copper surface, which significantly improves the mechanical interlocking and adhesion of the cobalt-doped bismuth oxide thin film. The micro-roughened surface provides more surface area for the film to bond with, ensuring a more stable and robust interface between the copper substrate and the deposited material. This step helps mitigate potential issues such as delamination or poor adhesion, which could negatively affect the electrochemical performance of the electrode material in applications like supercapacitors.

The cobalt-doped bismuth oxide layer is engineered to exhibit a bimodal pore size distribution, consisting of mesopores (2-5 nm) and macropores (50-100 nm). This unique structure is achieved by incorporating 0.05 wt % polyethylene glycol (PEG-4000) as a porogen during the preparation of the cationic precursor solution. The mesopores enhance the surface area of the thin film and provide more active sites for charge storage, while the macropores improve ion diffusion within the material, facilitating faster charge and discharge cycles. The combination of meso- and macropores optimizes both the capacitance and the rate performance of the material, which is critical for efficient energy storage and fast charge/discharge cycles in supercapacitors.

The copper substrate undergoes a dual-stage pre-cleaning process to ensure its surface is free from any contaminants or oxide layers that could interfere with film formation. First, the substrate is subjected to ultrasonic cleaning in a 2% isopropyl alcohol solution for 20 minutes. This step effectively removes organic residues and dirt particles from the surface. Following this, the copper is treated for 15 minutes in a 0.1 M HCl solution to remove any native oxide layer, ensuring a clean and reactive surface for the deposition of the thin film. This comprehensive pre-cleaning process ensures that the surface of the copper substrate is pristine, allowing for optimal adhesion and uniform film growth during the subsequent immersion in the NaOH solution.

By combining chemical etching, controlled pore engineering, and a thorough cleaning process, this embodiment ensures the formation of a highly adhesive, well-structured cobalt-doped bismuth oxide film with excellent electrochemical properties. The resulting electrode material demonstrates improved performance, particularly in terms of enhanced mechanical stability, increased charge storage capacity, and faster ion diffusion, making it ideal for high-performance energy storage devices.

For material used for the synthesis of electrode includes, Bi(NO₃)₃·5H₂O (Bismuth(III) nitrate pentahydrate pentahydrate 98% extra pure) and Co(NO₃)₂·6H₂O (cobalt nitrate hexahydrate 98% extra pure), H₂SO₄ (sulfuric acid), KOH (potassium hydroxide), PVA (polyvinyl alcohol), HNO₃ (nitric acid), acetone, and ethanol.

The copper substrate as a working electrode is polished using 1200-grade polished paper to achieve a refined surface. Following this, the electrodes underwent ultrasonic cleaning in a 10% HCl solution for 30-40 minutes to ensure thorough surface preparation. The SS substrates were then meticulously rinsed with acetone and distilled water to eliminate any remaining contaminants.

Cobalt-doped bismuth oxide electrode was produced using the SILAR method. Initially, a 0.1 M Bi(NO₃)·5H₂O solution was prepared as the cationic precursor, with a small addition of HNO3 to ensure clarity, followed by constant stirring for 4-5 hours. For the doped solution, 10% molar ratio of 0.1 M Co₂(OH)₂·6H₂O was mixed with 90% molar ratio of 0.1 M Bi(NO₃)₃·5H₂O. Flexible copper substrates, pre-cleaned and weighed, was interchangeably immersed in the cationic solution (Bi³⁺ & Co²⁺) for 60 seconds and rinsed with deionized water (DW) for 30 seconds to remove loosely bound ions. This was followed by immersion in an anionic precursor (OH⁻), created by diluting 1 M NaOH in DW, for another 60 seconds. This cycle was repeated 70 times. Post-deposition, the coated substrates were dried at room temperature for 12 hours and subsequently annealed at 573 K for 1 hour to convert the hydroxide film into oxide (Co₃O₄/Bi₂O₃/CuO), designated as CoBiCu₃₀₀ thin films. The resulting films were characterized to assess their electrochemical properties.

The synthesized nanomaterial electrode is experimentally assessed for supercapacitor properties measurements. The measuring supercapacitor properties include, using 1 M KOH electrolyte and copper substrates (with a thickness of 1 mm and dimensions of 1.5 cm²) as the base material. The active materials (AM), exemplified by CoBiCu₃₀₀ electrodes, served as the working electrodes. The electrolyte solution, consisting of 1 M KOH, was employed throughout the experimental procedures. Key electrochemical characterization techniques, including CV, GCD, and EIS, were conducted using an HCH 600D SPL electrochemical analyzer/workstation. Prior to immersion in the electrolyte, all electrodes underwent rigorous testing procedures. The potential window for together CV and GCD was set to −1.5 to 0.6 volts, ensuring consistent testing conditions across experiments. EIS measurements were performed with a voltage amplitude of 5 mV across a frequency spectrum extending from 100 Hz to 100 kHz. An electrochemical cell featuring three electrodes was utilized, comprising the 1 M KOH, a working electrode, a reference electrode (Ag/AgCl), and a counter electrode made of platinum wire. Capacitance values were determined by analyzing CV, GCD, and EIS data, employing methodologies consistent with established protocols from prior investigations. This systematic approach to experimental procedures ensures accurate and reliable measurements of supercapacitor properties, facilitating comprehensive analysis and comparison of electrode materials for energy storage applications.

For working electrode, SC, SE, and SP are estimated by using the formula given under:

$${C}_{s} = \int \frac{Idv}{2 \times s \times Δ V \times m} \qquad ( 1 )$$

Where ‘∫Idv’ is CV curve integral area, ‘S’ sweep rate in mV/s, ‘ΔV’ potential window in V, and ‘m’ active mass of material in mg.

$$SE = \frac{V \times {I}_{d} \times {t}_{d}}{m} \qquad ( 2 )$$

$$SP = \frac{V \times {I}_{d}}{m} \qquad ( 3 )$$

Where ‘V’ applied voltage, ‘I_{d}’ discharge current, ‘t_{d}’ discharging time, and ‘m’ active mass of material in mg.

The mechanism of the synthesis of said copper-supported cobalt-doped bismuth oxide nanomaterial electrode, is described as follows, Bismuth oxide (Bi₂O₃) exhibits unique electronic properties, including high ionic conductivity and a broad potential window, wherein doping Doping Bi₂O₃ with transition metals, such as cobalt, can further enhance its electrical conductivity, surface area, and electrochemical stability, making it suitable material for supercapacitor electrodes. The SILAR technique used in the present invention offers a facile and cost-effective approach to synthesizing nanostructured materials with precise control over composition and thickness. By supporting cobalt-doped Bi₂O₃ on copper substrates, which serve as both a conductive support and a current collector, the overall performance of the electrode can be significantly improved. The present invention utilizes the intrinsic properties of cobalt-doped Bi₂O₃, and excellent electrical conductivity and mechanical flexibility of copper, wherein these properties results in an electrode material with enhanced capacitance, stability, and charge-discharge efficiency, making it compelling choice for next-generation supercapacitors.

The mechanism of the synthesis (CoBiCu₃₀₀ Thin Film Formation) is as given under:

The reactions important to the creation of cobalt oxide/bismuth oxide/copper oxide are shown as follows:

Bi(NO₃)₃·5H₂O+Co(NO₃)₂·6H₂O+HNO₃+H₂O→Bi³⁺+Co²⁺+6NO₃⁻+13H⁺+12OH⁻

NaOH+H₂O→Na⁺+2OH⁻+H⁺

Bi³⁺+3OH⁻→Bi(OH)₃

Co²⁺+2OH⁻→Co(OH)₂

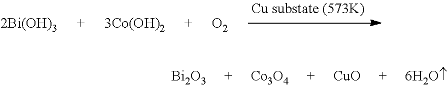

Final enhanced sample of cobalt oxide/bismuth oxide/copper oxide (CoBiCu₃₀₀) used for dissimilar physical and chemical characterization methods.

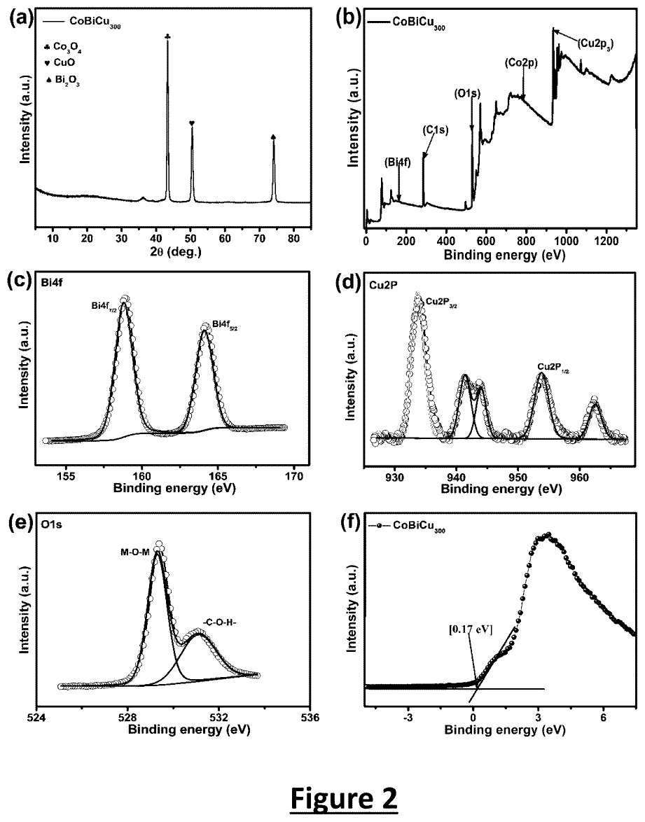

FIG. 2 illustrates (a) XRD data of sample CoBiCu₃₀₀, (b) survey spectra of sample CoBiCu₃₀₀, deconvoluted XPS of (c) Bi 4f, (d) Cu 2p, (e) O 1s, (f) XPS valance band spectra of sample CoBiCu₃₀₀, in accordance with an embodiment of the present disclosure.

The structural properties of the synthesized sample CoBiCu₃₀₀ material were characterized through XRD analysis, as depicted in FIG. 2 (a). The XRD spectra of all samples revealed three distinct peaks corresponding to specific orientations: (400) for Co₃O₄, (−202) for CuO, and (623) for Bi₂O₃. Specifically, the XRD peak for Co₃O₄ was observed at 43.25°, which aligns with the face-centered cubic (FCC) structure as documented in JCPDS No. 43-1003. The CuO peak appeared at 50.54°, indicative of the monoclinic phase as per JCPDS No. 02-1225, while the Bi₂O₃ peak was located at 74.13°, corresponding to its tetragonal crystal structure noted in JCPDS No. 29-0236. Among these, the Co₃O₄ (400) peak exhibited the most intense reflection, suggesting a predominant phase presence in the material. The absence of other peaks in the XRD pattern suggests minimal reorientation during the synthesis of the new material. For crystallite size determination, Debye-Scherrer's formula in equation (4) was applied. This method provides a valuable quantitative measure of the crystalline dimensions, crucial for understanding the material's potential. The data affirm that the synthesized sample CoBiCu₃₀₀ has well-defined crystalline phases, indicating successful synthesis and potential for further exploration.

$$D = \frac{K λ}{βCos θ} \qquad ( 4 )$$

Where, K characterizes a Scherrer constant (0.98), ‘λ’ was wavelength of X-ray, ‘β’ full-width at half-maximum (FWHM) and ‘θ’ diffraction angle. The average crystallite size was initiate to be approximately near about (≈19 to 22 nm) of sample CoBiCu₃₀₀.

The XPS analysis was conducted to determine the composition and atomic valence states of Bi, Co, Cu, O, and C in the active materials. A survey spectrum, illustrated in FIG. 2(b), reveal a binding energy of Bi 4f at 162.10 eV, Co 2p at 794.78 eV, Cu 2p at 935.24 eV, O 1s at 530.12 eV, and C 1s at 284.98 eV. Detailed XPS spectra of Bi 4f, shown in FIG. 2(c), indicate spin-orbit splitting at 158.7 eV and 164.0 eV, corresponding to Bi 4f_{7/2} and Bi 4f_{5/2}, individually. These peaks suggest that Bi is present in bismuth oxide by a 3⁺ oxidation state, corroborated by the 5.3 eV energy separation between the two Bi 4f peaks. Additionally, shakeup satellites were observed at approximately 941.38 eV and 962.42 eV. The high-resolution XPS spectrum of the Cu 2p state, depicted in FIG. 1 (d), exhibit two main peaks with a horizontal separation of 19.94 eV, centered at 933.99 eV and 953.9 eV, indicative of the Cu 2p_{3/2} and Cu 2p_{1/2} states, respectively, both with a 2⁺ oxidation state. FIG. 2(e) presents the deconvoluted O1s region into two peaks at binding energies of 529.38 eV and 531.08 eV, corresponding to different core levels of oxygen. The stoichiometric ratios of Bi, Co, Cu, and O were quantified as 3.67%, 0.33%, 16.29%, and 32.26%, respectively. Further analysis of the valence band spectra (FIG. 2 (f)) identified the valence band edge of the sample CoBiCu₃₀₀ at 0.17 eV. This comprehensive XPS analysis not only elucidates the oxidation states and chemical environment of the elements present but also provides critical insights into the electronic structure and stoichiometry of the materials under investigation. The observed binding energies and valence states align well with the expected chemical states, confirming the presence and interaction of these elements within the material matrix, essential for understanding their functional properties.

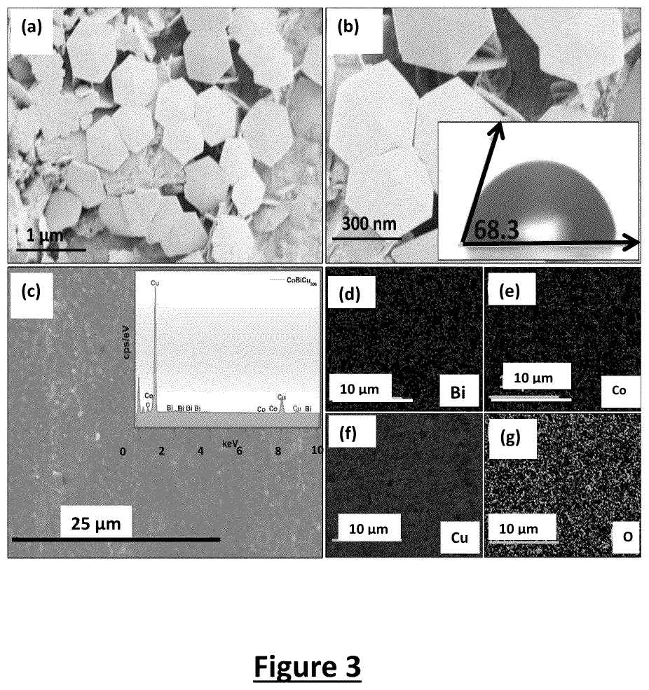

FIG. 3 illustrates (a-b) FE-SEM images of sample CoBiCu300, (c) Elemental mapping images of a sample CoBiCu₃₀₀, (d) Bi, (e) Co, (f) Cu, (g) O, and inset of (c) EDAX spectra of sample CoBiCu₃₀₀ in accordance with an embodiment of the present disclosure.

The morphological development of the CoBiCu₃₀₀ sample, synthesized with a cobalt to bismuth ratio of 10% Co to 90% Bi, was thoroughly examined using FE-SEM. The FE-SEM images presented in FIG. 3(a-b) reveal significant morphological changes as a consequence of this specific Co ratio. The CoBiCu₃₀₀ sample, comprising cobalt oxide, bismuth oxide, and copper oxide, demonstrated a distinctive morphology characterized by the formation of hexagonal nanosheets. These nanosheets exhibited an average length of approximately 149 nm. The high-resolution FE-SEM images highlight the uniformity and well-defined edges of these hexagonal nanosheets, indicating a high degree of crystallinity and suggesting efficient interaction between the constituent metal oxides. The hexagonal nanosheet structure likely arises from the intrinsic crystalline properties of the individual oxides and the synergistic effects resulting from their combination in this specific ratio.

The wettability of the CoBiCu₃₀₀ sample was characterized by measuring its contact angle, as revealed in the inset of FIG. 3(b), which was found to be 68.3°, indicating its hydrophilic nature. The relatively low contact angle implies a high surface energy that promotes water spreading, likely due to the presence of cobalt oxide, bismuth oxide, and copper oxide within the hexagonal nanosheets. This property enhances the materials performance in aqueous environments, improves dispersion stability in water-based suspensions, and allows for potential surface modifications to further tailor it was wettability. The hydrophilic nature also suggests potential for high reactivity and efficiency in catalytic processes involving aqueous solutions.

The Energy-dispersive X-ray analysis (EDAX) spectra of the ideal thin film, depicted in FIG. 3 (c) with a detailed, reveal the atomic percentages of the constituent elements: Bi, Co, Cu, and O, which are 5.24%, 2.71%, 77.86%, and 14.19%, respectively. This composition highlights a copper-dominant matrix with substantial oxygen content, indicating the presence of metal oxides. The relatively high copper percentage suggests a predominant copper oxide phase, while the presence of bismuth and cobalt in smaller amounts implies their roles in modifying the materials properties, such as enhancing electrical conductivity. The oxygen content aligns with the formation of metal oxides, which is consistent with the hydrophilic nature observed in the wettability analysis.

As shown in FIG. 3(c-g), EDAX elemental mapping was employed to identify and visualize the distribution of the components within the CoBiCu₃₀₀ sample. The elemental mappings confirm the presence of bismuth (Bi), cobalt (Co), copper (Cu), and oxygen (O), revealing that all four elements are uniformly distributed throughout the sample, as illustrated in FIG. 3(c). The individual mapping images for Bi, Co, Cu, and O are presented in FIG. 3(d-g), respectively, demonstrating consistent dispersion without significant agglomeration or segregation of any single element. This uniform distribution is indicative of a homogeneous mixture at the nanoscale, which is crucial for ensuring consistent material properties and performance.

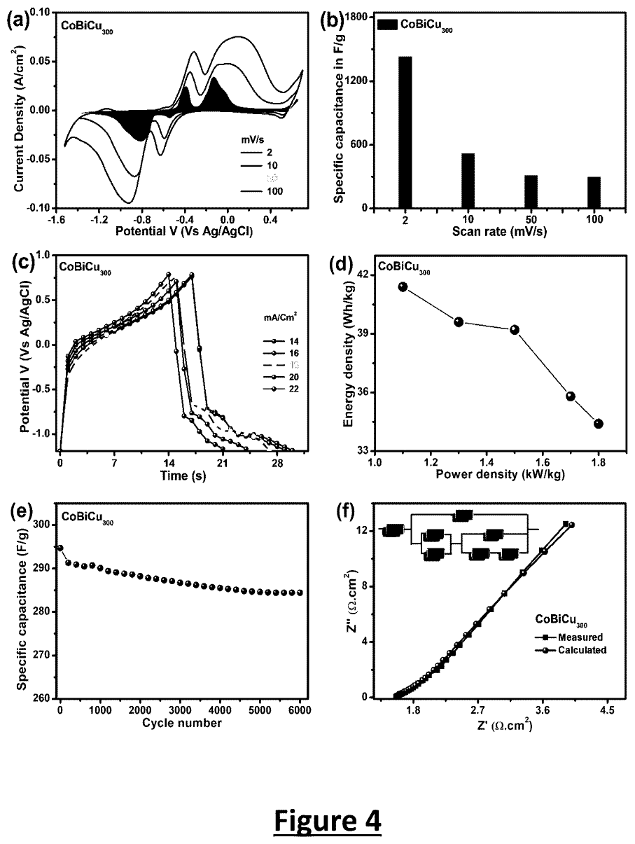

FIG. 4 illustrates (a) The CV curve of electrode CoBiCu300 at dissimilar scan rate in 1M KOH electrolyte, (b) Regon plot of Cs in F/g vs sweep rate in mV/s, (c) GCD plot of electrode CoBiCu300 at different current density in mA/cm2, (d) Regon plot of SE vs SP of electrode CoBiCu300, (e) stability curve of electrode CoBiCu300 in 1M KOH electrolyte, (f) EIS Nyquist plot and its Matched Nyquist plot with circuit of electrode CoBiCu₃₀₀ in accordance with an embodiment of the present disclosure.

As shown in FIG. 4 (a), the cyclic voltammetry (CV) curves of the CoBiCu₃₀₀ electrode was examined at numerous sweep rates ranging from 2 to 100 mV/s in a 1 M KOH solution, within a potential window of −1.5 to 0.6 V versus Ag/AgCl. All CV curves exhibited mixed capacitive behavior, indicating pseudocapacitance. The specific capacitance (Cs) values for the CoBiCu₃₀₀ electrode, presented in FIG. 4 (b), were 1430.7 F/g at 2 mV/s, 515.1 F/g at 10 mV/s, 311.2 F/g at 50 mV/s, and 294.7 F/g at 100 mV/s. The decreasing SC values with increasing scan rates suggest that at higher scan rates, the redox reactions are less efficient due to increased charge and mass transfer resistance, compounded by the IR drop. This behavior highlights the material's excellent capacitive performance at lower scan rates, making it suitable for applications requiring high energy storage capacity. The unique morphology is beneficial as it increases the material's surface area, which is crucial for applications that require high surface reactivity. The formation of such well-defined nanosheets implies a controlled and precise synthesis process, which is essential for tailoring the material properties for specific applications like supercapacitor applications.

The galvanostatic charge-discharge (GCD) method was employed to characterize a charge and discharge performance of the CoBiCu₃₀₀ electrode at various current densities, ranging from 14 to 22 mA/cm², at an operating potential of 2.1 V. FIG. 4 (c) illustrates that the charge-discharge time decreased with increasing current density, suggesting a tendency toward linear behavior. This trend indicates the electrode ability to efficiently store and release charge, albeit with shorter charge-discharge times at higher current densities. FIG. 4(d) presents the electrical parameters specific energy (SE) and specific power (SP) appraised for diverse current densities. The highest SE values were observed at minor current densities, with a gradual decrease as the current density increased. Conversely, SP values exhibited an increasing trend with current density. These observations suggest that the electrode's morphology and crystalline behavior play a crucial role in determining its electrochemical performance. The shortest diffusion lengths and efficient charge transport, facilitated by the material's strong morphology and crystalline structure, likely contribute to the highest SE and SP values. Furthermore, the presence of an IR drop, as indicated, underscores the importance of considering internal resistances when evaluating the performance of energy storage devices.

FIG. 4(e) depicts the cyclic stability of a CoBiCu₃₀₀ electrode, evaluated over 6000 cycles using CV at a constant sweep rate of 100 mV/s. The electrode maintains 96.5% of its initial capacitance value throughout the entire cycling period, demonstrating excellent cyclic stability. However, the gradual reduction in capacitance with cycling can be attributed to the detachment and microstructural changes of the active material during the Faradaic process. Despite these changes, the CoBiCu₃₀₀ electrode exhibits impressive capacitance retention, indicating its robustness and durability under prolonged cycling conditions. This exceptional cyclic stability is a desirable characteristic for energy storage devices, as it ensures long-term reliability and performance consistency in practical applications.

The Nyquist plots presented in FIG. 4(f) depict the results of electrochemical impedance spectroscopy (EIS) experiments conducted in 1 M KOH electrolytes. In these plots, the internal resistance of the system was measured to be 1.5Ω. Specifically, the Nyquist plot for the CoBiCu₃₀₀ electrode was obtained experimentally and analyzed using ZsimpWin simulation software, resulting in a matched equivalent circuit as displayed in the inset of FIG. 4(f). The circuitry parameters of the CoBiCu₃₀₀ electrode, including charge transfer resistance (R_{S}=1.585Ω), charge transfer resistance associated with the Faradaic process (R_{CT}=1.422Ω), inductance (R_{L}=716.7Ω), and constant phase elements (CPE), were determined. The presence of multiple CPE elements suggests the complex nature of the electrode-electrolyte interface, reflecting variations in surface properties and electrolyte behavior. CPE=4.716×10⁻⁵ F, CPE=2.54×10⁻² F, CPE=1.738×10⁻⁴ F, and W=2.479×10⁻⁵ F. The obtained Nyquist plot and associated circuit parameters provide valuable insights into the electrochemical behavior and performance of the CoBiCu₃₀₀ electrode, offering a comprehensive understanding of its impedance characteristics and facilitating the design and optimization of high-performance energy storage devices. Additionally, the ability to accurately model and interpret Nyquist plots enhances the predictive capabilities for device performance and guides the development of strategies to minimize internal resistance and improve overall electrochemical performance.

The aforementioned results from the experimental evaluation of the synthesized revealed that the strategic incorporation of copper and cobalt doping within the Bi₂O₃ matrix synergistically enhances the overall electrochemical behavior, facilitating efficient charge transfer and storage. Notably, the SILAR technique ensures uniform and conformal coating of copper onto the cobalt-doped Bi₂O₃ nanoparticles, minimizing defects and maximizing active surface area, thereby optimizing electrode performance. The resulting electrode material exhibits exceptional charge storage capacity, quick charge-discharge kinetics, and long-term stability, surpassing the limitations of conventionally synthesized counterparts. Such remarkable electrochemical attributes position this novel electrode material as a frontrunner for advancing supercapacitor technology, meeting the escalating demands for high-performance energy storage solutions in diverse applications spanning portable electronics, renewable energy systems, and electric vehicles. Consequently, the present invention not only signifies a significant technological advancement but also holds substantial commercial potential, promising lucrative opportunities in the burgeoning energy storage market landscape.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A process for synthesizing Copper-supported Cobalt-doped Bismuth oxide nanomaterial electrodes for supercapacitor applications, comprising:
(a) preparing a 0.1 M Bismuth(III) nitrate pentahydrate Bi(NO₃)₃·5H₂O solution as the cationic precursor and mixing with a small quantity of nitric acid (HNO₃) for solubility;
(b) stirring cationic solution for 4-5 hours;
(c) doping the cationic solution by adding a 10% molar ratio of cobalt(II) nitrate hexahydrate Co(NO₃)₂·6H₂O to 90% molar ratio of 0.1 M Bismuth(III) nitrate pentahydrate Bi(NO₃)₃·5H₂O solution to form a doped solution;
(d) immersing a pre-cleaned copper substrate in an anionic precursor solution of OH⁻ ions, prepared by diluting 1 M NaOH in deionized water, for 60 seconds;
(e) repeating the immersion cycle 50-100 times to form a thin film on the copper substrate; and
(f) drying the coated copper substrate at room temperature for 12 hours, followed by annealing at 400-100 K for 0.5-2 hours to convert the hydroxide film into a composite oxide film.

2. The process of claim 1, wherein the cobalt-doped bismuth oxide thin films are deposited using a successive ionic layer adsorption and reaction (SILAR) technique to create CoBiCu₃₀₀ thin films exhibit improved electrochemical performance.

3. The process of claim 1, wherein the weight percentage of the cobalt(II) nitrate hexahydrate Co(NO₃)₂·6H₂O is 8% and 10% of the total weight, Bismuth(III) nitrate pentahydrate Bi(NO₃)₃·5H₂O solution is 80% to 82% of the total weight of the solution, nitric acid (HNO₃) is 1% to 2% of the total weight, and deionized water, is 8% to 10% of the total weight.

4. The process of claim 1, wherein the pre-cleaning of the copper substrate comprises steps of:
polishing the copper substrate using polishing paper to achieve a refined surface;
subjecting the polished copper substrate to ultrasonic cleaning in a 10% hydrochloric acid (HCl) solution for 30-40 minutes to ensure thorough surface preparation;
rinsing the cleaned copper substrate with acetone to remove any residual contaminants after ultrasonic cleaning; and
rinsing the copper substrate with distilled water after acetone rinsing to eliminate any remaining chemical residues.

5. The process of claim 1, wherein the coated copper substrate is annealed at 573 K for 1 hour to convert the hydroxide film into a composite oxide film comprising Co₃O₄, Bi₂O₃, and CuO.

6. The process of claim 5, wherein the copper substrate is polished using 1200-grade polishing paper.

7. The process of claim 3, wherein the cobalt-doped bismuth oxide layer has a molar ratio of cobalt to bismuth of about 10:90.

8. The process of claim 3, wherein the cobalt-doped bismuth oxide layer is formed by a successive ionic layer adsorption.

9. The process of claim 3, wherein said (SILAR) technique comprises:
a. Immersion in the doped cationic solution for 60 seconds to adsorb Bi³⁺ and Co²⁺ ions;
b. Rinsing in deionized water for 30 seconds to remove unbound ions;
c. Immersion in the anionic solution for 60 seconds to form a hydroxide layer via reaction with the adsorbed ions; and
d. Rinsing in deionized water for 30 seconds to eliminate excess hydroxide ions;

10. The process of claim 9, wherein the immersion steps are repeated about 70 times.

11. The process of claim 5, wherein the annealing at 573 K is preceded by a preheating stage at 200 K for 20 minutes to gradually remove residual moisture and volatile compounds, preventing microcrack formation in the Co₃O₄—Bi₂O₃—CuO composite layer, and wherein the conversion of the hydroxide film into a composite oxide film is further enhanced by a rapid cooling phase after annealing, wherein the substrate is exposed to an ice bath for 2 minutes to induce phase separation and create an improved electrochemical interface.

12. The process of claim 5, wherein the annealing temperature is incrementally increased by 10 K every 15 minutes from 300 K to 573 K, under a controlled nitrogen atmosphere at a flow rate of 150 Standard Cubic Centimeters per Minute (sccm), to minimize any rapid thermal expansion that could cause delamination of the film, and wherein the film thickness is controlled by adjusting the number of SILAR cycles and maintaining a constant precursor concentration, resulting in a highly uniform thin film with a thickness of 70 nm±5 nm, as verified by profilometry, and wherein the cobalt-doped bismuth oxide film exhibits an average crystallite size of 20-30 nm, determined by X-ray diffraction (XRD), after annealing, which improves the charge storage capacity of the electrode material.

13. The process of claim 2, wherein a pulsed electric field is applied at a frequency of 1 Hz with a 1-second on-time and 1-second off-time, generating a peak electric field strength of 1.2 V/cm to enhance the ion diffusion rate and increase the doping efficiency during each cycle, and wherein the pulsed electric field is generated using a square wave signal with a duty cycle of 50% during immersion, resulting in a more homogeneous ion distribution and an increase in the adhesion strength of the cobalt-doped bismuth oxide layer on the copper substrate, and wherein the pulsed electric field is applied in conjunction with an alternating magnetic field at 0.5 mT to further promote ion migration and prevent agglomeration of cobalt and bismuth ions during the deposition process.

14. The process of claim 9, wherein the immersion in the doped cationic solution is performed under continuous ultrasonic agitation at 40 kHz to enhance ion diffusion and promote the formation of densely packed nanostructures, wherein each immersion cycle includes a cathodic polarization step at −0.2 V versus Ag/AgCl for 15 seconds to enhance the selective reduction and deposition of cobalt ions onto the copper substrate, and wherein the cationic solution is stirred at a constant rate of 350 rpm using a magnetic stirrer for the entire 4-5 hour period to maintain homogeneity and prevent precipitation of Bi³⁺ and Co²⁺ ions before SILAR deposition.

15. The process of claim 1, wherein the copper substrate surface is chemically etched using a 0.1 M ammonium persulfate (NH₄)₂S₂O₈ solution for exactly 90 seconds prior to SILAR deposition to create micro-roughness, improving mechanical interlocking and adhesion of the thin film, wherein the cobalt-doped bismuth oxide layer is engineered to exhibit a bimodal pore size distribution with mesopores of 2-5 nm and macropores of 50-100 nm, achieved by incorporating 0.05 wt % polyethylene glycol (PEG-4000) as a porogen during the cationic precursor preparation, and wherein the copper substrate is pre-cleaned using a dual-stage process, consisting of first an ultrasonic cleaning in a 2% isopropyl alcohol solution for 20 minutes, followed by a 15-minute treatment in a 0.1 M HCl solution to remove any oxide layer, before proceeding to immersion in the NaOH solution.

16. The process of claim 9, wherein the immersion in the NaOH solution occurs at a temperature of 45° C., while maintaining the pH between 12.5 and 13.0 to control the solubility of cobalt and bismuth hydroxides and ensure their uniform deposition on the copper substrate.

17. A Copper-supported Cobalt-doped Bismuth oxide nanomaterial electrode composition formed according to the process of claim 1, comprising:
10% molar ratio of cobalt(II) nitrate hexahydrate Co(NO₃)₂·6H₂O;
90% molar ratio of 0.1 M Bismuth(III) nitrate pentahydrate Bi(NO₃)₃·5H₂O solution with a small quantity of nitric acid (HNO₃); and
1 M NaOH in deionized water.

18. The composition of claim 17, wherein the weight percentage of the cobalt(II) nitrate hexahydrate Co(NO₃)₂·6H₂O is 8% and 10% of the total weight, Bismuth(III) nitrate pentahydrate Bi(NO₃)₃·5H₂O solution is 80% to 82% of the total weight of the solution, nitric acid (HNO₃) is 1% to 2% of the total weight, and deionized water, is 8% to 10% of the total weight.

19. The composition of claim 18, wherein the weight percentage of the cobalt(II) nitrate hexahydrate Co(NO₃)₂·6H₂O is 9% of the total weight, Bismuth(III) nitrate pentahydrate Bi(NO₃)₃·5H₂O solution is 81% of the total weight of the solution, nitric acid (HNO₃) is 1% of the total weight, and deionized water, is 9% of the total weight.
